(19) United States
(12) Patent Application Publication
(10) Pub. No.: US 2026/0212287 A1
(43) Pub. Date: Jul. 23, 2026

(54) CONSTRAINT ENFORCEMENT ON SUPERVISED ALGORITHMS

(71) Applicant: FMR LLC, Boston, MA (US)

(72) Inventors: Aniruddhan Pillaipakkam Naatu, Tamil Nadu (IN); Ranjith Kalyana Sundaram, Tamil Nadu (IN); Arun Karthick Alagarsamy, Tamil Nadu (IN)

(21) Appl. No.: 19/034,202

(22) Filed: Jan. 22, 2025

(51) Int. Cl. G06Q 10/0631; G06F 18/24

(52) U.S. Cl. CPC G06Q 10/06311; G06F 18/24

(57) ABSTRACT

A computerized method is provided for accurately and automatically classifying members of a data group such as clients in a service industry by complexity or service/staffing requirements. Instead of relying solely on machine learning analysis to attempt to identify and rank data features contributing to group member classification, systems and methods herein can apply constrained machine learning such as genetic algorithms trained with input data from subject matter experts. Accordingly feature weights can be determined with expert context accounted for to more accurately assess group member classification.

### TECHNICAL FIELD

This application relates generally to systems, methods, and apparatuses, including computer program products, for constrained enforcement of supervised machine learning algorithms.

### BACKGROUND

Modern corporate decisions, including evaluating and staffing clients in service-based industries, remain a nuanced art relying on human experience while resisting automation and quantification. For example, in financial services, understanding information like complexity of a client relationship or capacity required to service the client is still requires painstaking evaluation by experienced relationship managers to get right with dire consequences for getting wrong. In underestimating client complexity and/or understaffing a new client, a service company risks making a negative impression, failing to adequately serve the client, making careless errors, and otherwise endangering the relationship. In overestimating and/or overstaffing, a service company wastes precious resources, hurting the efficiency, the bottom line, and potentially underserving other clients from which those resources are drawn.

Attempts to automate data evaluation in such instances have included using supervised machine learning algorithms but these can often capture a spurious relationship (i.e., noise) rather than legitimate relationship characteristics that can be generalized and applied across different datasets.

### SUMMARY

Systems and methods of the invention provide the learning capability of supervised machine learning algorithms and constrained optimization features of genetic algorithms to determine the effect of a large number of variables with their relative importance by computing an optimal set of weights through iteration across various combinations of weights for each of these variables relative to another as well as to values or value ranges within each of the variables. Applied to the examples above, systems and methods of the invention can be used to automatically, and accurately determine client complexity by optimizing the weight of each client feature (e.g., client size) as well as the weight of each value therein (e.g., less than 1,000 employees or more than 10,000 employees). The systems and methods herein can thereby provide flexibility to an analyst to define the effect of each feature and derive an optimal set of weights for each of the variables. This can be accomplished with sample data from existing clients and the optimized weights can then be applied to new clients to provide de novo complexity scores without the need for costly and potentially erroneous personal evaluation by relationship managers.

Aspects of the invention can include a computerized method for classifying data group members by features thereof. Methods can include providing to a constrained genetic algorithm each of 1) a sample group, each sample group member comprising a plurality of data features, each of the plurality of data features comprising a feature value; 2) a classification for each member of the sample group; 3) a selection of influential features selected from the plurality of data features; 4) a relative qualitative rank of the selection of influential features; and 5) a relative internal weight for each feature value of the selection of influential features. Methods can then use the constrained genetic algorithm to determine optimized weights for each of the selection of influential features and each feature value of the selection of influential features based on contribution to the classification. The determined weights can then be used to classify a new group member.

In various embodiments, the classification for each member of the sample group can be determined by one or more subject matter experts. The selection of influential features can be selected by one or more subject matter experts. The relative qualitative rank of the selection of influential features and the relative internal weight for each feature value of the selection of influential features may both be determined by one or more subject matter experts.

In certain embodiments, each sample group member and the new group member can consist of a business client. Classification can be selected from client complexity, required time for client management, required knowledge for client management, or required staffing for client management for the business client. The business client may be a financial services client. The features can comprise one or more of client assets, number of plans, number of participants, client distance, client industry, client tenure, and products used by client. The one or more subject matter experts can comprise experienced client relationship managers. In some embodiments, methods can include determining staffing for the new client based off the classification of the new client. Determining staffing can include assigning a specific number, experience level, or skill rating of client relationship manager to the new client.

In certain aspects, systems of the invention can include a computer system for classifying data group members by features. The system can comprise a processor in communication with a non-transient memory and operable to perform the steps of providing to a constrained genetic algorithm: each of 1) a sample group, each sample group member comprising a plurality of data features, each of the plurality of data features comprising a feature value; 2) a classification for each member of the sample group; 3) a selection of influential features selected from the plurality of data features; 4) a relative qualitative rank of the selection of influential features; and 5) a relative internal weight for each feature value of the selection of influential features. Methods can then use the constrained genetic algorithm to determine optimized weights for each of the selection of influential features and each feature value of the selection of influential features based on contribution to the classification. The determined weights can then be used to classify a new group member.

In various embodiments, the classification can be according to complexity and may be ranked with a value of low, moderate, and high. The relative qualitative rankings and/or the relative internal weight for each feature value may be assigned a value of low, moderate, high, and very high. Optimization can then be used to determine a corresponding numerical weight (e.g., 1, 2, 3, or 4) for each relative internal weight for each feature value as well as each relative qualitative ranking for each feature. Weights can be applied by multiplying each relative internal weight for each feature value by the relative qualitative ranking for that feature to obtain a dot product of weights.

For example, for a financial services application, one feature used to determine client complexity may include client assets under management. That feature may be determined by subject matter experts to rank very high among all features in contributing to client complexity while the number of plans offered to that client may be considered to rank as a moderate contributing factor. Within those features, ranges of values would be assigned a rank (e.g., assets over thirty billion might be rated as very high relative complexity while assets under one billion may be rated as low relative complexity). Systems and methods of the invention can then use a constrained genetic optimization to assign a numerical value to each of these ratings that best translates the raw data of feature values to an overall client complexity score.

Initially, the category or feature rankings, weights, or scores can be assigned an arbitrary weight (e.g., low=1, moderate=2, high=3, and very high=4). If client complexity is calculated as a function of the weighted features, a fitness score can be calculated based on the sample data (e.g., established client complexity ratings for existing clients) and the numerical weights for each feature ranking can be optimized be genetic algorithm to maximize the fitness score. In various embodiments, the complexity calculation may be represented as: Complexity=f (feature1, feature2 . . . , feature n) and the fitness function may be represented as:

$$\begin{matrix}\begin{matrix}maximize \\ ( f 1 score )\end{matrix} = \frac{2 * tp}{( 2 * tp ) + fp + fn} \\ \cdot tp - true positives , tn - true negatives \\ \cdot fp - false positives , fn - false negatives\end{matrix}$$

A second optimization can then be performed on weights for the individual values or value ranges within each category to maximize a fitness score in a fitness function for a client complexity function using the optimized weights of the categories from the first optimization along with the sample data. The complexity function can then be evaluated and the optimization validated on additional sample data.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for classifying members of a data group based on features thereof.

FIG. 2 shows an exemplary method for classifying members of a data group based on features thereof.

FIG. 3 illustrates assignment of client complexity ratings and feature and feature value ratings as a contributing factor to that complexity as obtained by subject matter experts and used to constrain a machine learning algorithm.

FIG. 4 illustrates feature value weighting as a dot product of qualitative feature value rankings and qualitative feature rankings.

FIG. 5 illustrates client complexity determined as a function of client feature values.

FIG. 6 illustrates application of a constrained genetic algorithm to determine feature and feature value weights in evaluating client complexity.

FIG. 7 shows a user interface for entering expert rankings/rating for training a complexity evaluation model.

FIG. 8 shows a user interface providing determined feature value weights based on the training input.

### DETAILED DESCRIPTION

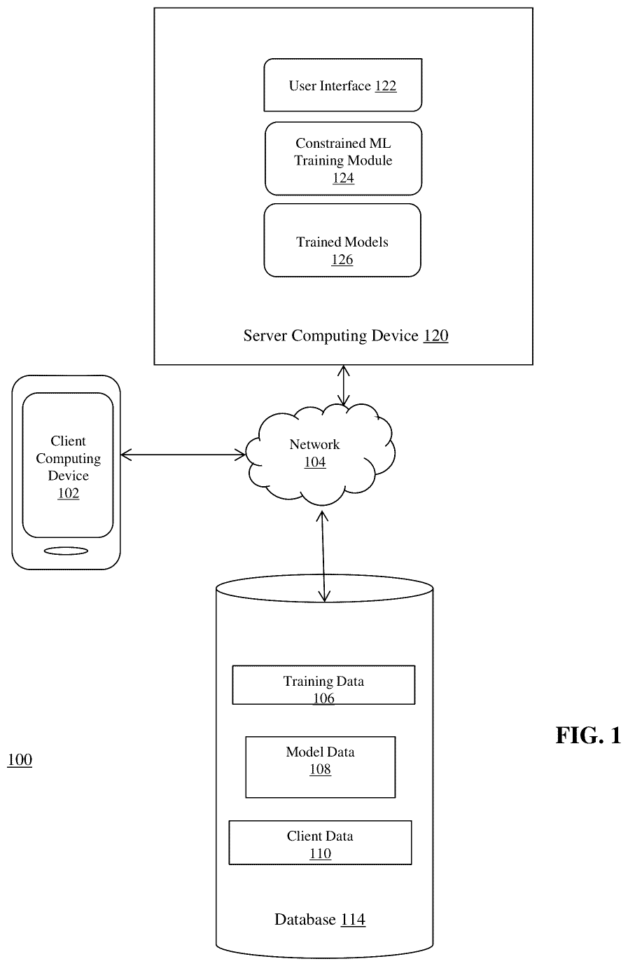

FIG. 1 is a block diagram of an exemplary system 100 for classifying members of a data group based on features thereof. The system 100 includes a client computing device 102, a communications network 104, a server computing device 120 that includes a user interface 122, a constrained machine learning (ML) module 124 for training group classifiers, and one or more trained models 126 for evaluating/classifying group members. The system 100 also includes a database 114 storing training data 106, model data, and client data 110.

The client computing device 102 connects to one or more communications networks (e.g., network 104) in order to communicate with the server computing device 120 to provide input and receive output relating to data group member classification. Administrators, relationship managers, client intake personnel, and/or other users may interact, through the user interface 122, with the constrained ML training module 124 and/or any trained models 126 via a client computing device 102. For example, a user interface 122 displayed on the client computing device 102 and/or one or more input/output devices can allow an administrator to provide input data to the constrained ML training module 121, manage settings therein, and/or provide new client data to trained models 126 for classification. In various embodiments, the user interface 122 may be local to the client computing device 102 or may reside on the server computing device 120 as shown in FIG. 1.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used in conjunction with applications or modules on the server computing device 120. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., execute training sessions or review scores). Generally, a browser application comprises software executing on a processor of the client computing device 102 that enables the client computing device to communicate via HTTP or HTTPS with remote servers addressable with URLs (e.g., server computing device 120) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 120 and the database 114 in certain embodiments. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 120 is a device including specialized hardware and/or software modules that execute on a processor and interact with memory modules of the server computing device 120, to receive data from other components of the system 100, transmit data to other components of the system 100, and perform functions (e.g., train a group classifier with input data or classify new group members). As discussed above the server computing device 120 includes a user interface 122, a constrained machine learning (ML) module 124 for training group classifiers, and one or more trained models 126 for evaluating/classifying group members. The constrained ML module 124 is operable to receive input data including sample group members (e.g., financial services clients) with known classifications (e.g., complexity ratings) along with selected features of the group members, qualitative rankings thereof, and specific feature values for each of the sample group members. Based on that input data, the constrained ML module 124 can train classification models 126 that can then accurately evaluate and classify new group members. The trained models 126 can receive inputs such as new group member feature data and return a classification as discussed below.

The server computing device 120 may include any number of other programs that may execute on the processor of the server computing device 120 and may each, despite being disparate programs, rely on a regular exchange of data between them and/or the database 114. In some embodiments, the various modules, programs, or applications are specialized sets of computer software instructions programmed onto one or more dedicated processors in the server computing device 120 and can include specifically designated memory locations and/or registers for executing the specialized computer software instructions.

Although the applications and modules are shown in FIG. 1 as executing within the same server computing device 120, in some embodiments the functionality of the applications and modules can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the applications, programs, and/or modules is described in detail throughout this specification.

The database 114 is a computing device (or in some embodiments, a set of computing devices) coupled to the server computing device 120 and is configured to receive, generate, and store specific segments of data relating to clients (group members) and classification thereof. In some embodiments, all or a portion of the database 114 can be integrated with the server computing device 120 or be located on a separate computing device or devices. The database 114 can comprise one or more databases configured to store portions of data used by the other components of the system 100, as will be described in greater detail below.

In some embodiments, the database 114 comprises one or more training data repositories 106 storing various input data for training classification models. For example, this data can include expert input regarding classifications of sample group members, feature selections, and qualitative rankings thereof. The database 114 can also include a model data repository 108 wherein the data supporting any trained models 126 may be stored.

The database 114 can include one or more group member or client data repositories 110 that can be accessed by either the constrained ML training module 124 or the trained classification models 126 in order to provide input data such as feature values for training or classification.

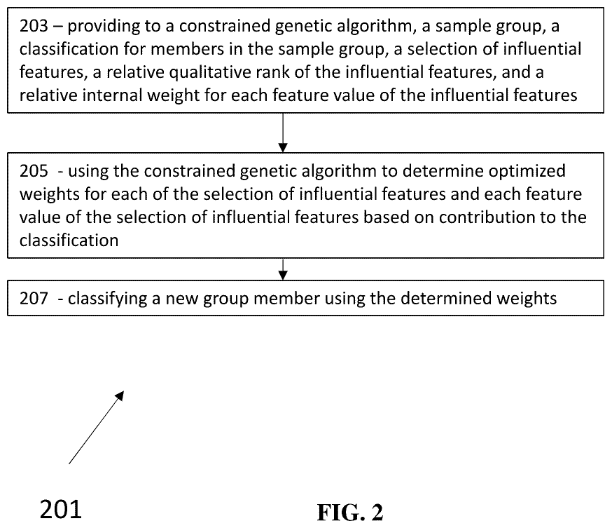

FIG. 2 shows an exemplary method 201 for classifying members of a data group based on features thereof. A server computing device 120 operating a constrained genetic algorithm is provided 203 with data from a client computing device via a user interface and instructed to perform an analysis. That data can include a sample group, a classification for members in the sample group, a selection of influential features, a relative qualitative rank of the influential features, and a relative internal weight for each feature value of the influential features. The data can be provided by a user including subject matter experts of administrators tasked with training the evaluation model. An application on the server computer system or the client computing system can cause the user interface displayed on the client computing system to prompt the user for the required information to create the model. For example, the system may prompt the user to enter one or more group features that an expert deems contributory to the desired classifications. The system can then prompt the user to rank the contribution of those features to the overall classification. The system can also prompt the user to provide a sample group (e.g., existing clients) along with the classification for the members of the sample group (e.g., complexity of each client) along with the feature values for each of the ranked contributory features entered above for the group members. That sample data can be entered via the user interface or may be accessed from a database or other repository in response to user input. For example, after a user has entered a set of influential or contributory features and a sample group, the system may access company databases to find the values for each group member for each feature and automatically populate that information for model construction using the constrained algorithm. The user interface can also prompt for the additional information including definitions of values or value ranges for each of the identified influential features and a qualitative expert ranking of those values or value range's contribution to the classification (e.g., client complexity).

For example, the user, based on personal expert knowledge or group consensus solicited from a plurality of experts, may identify that for organization complexity of financial services clients, client assets (e.g., the amount of money being managed for the client), number of participants (e.g., the number of employees participating in a financial services plan), and the number of plans (e.g., the variety of financial services plans offered to the employees at the client) are key features that contribute to complexity. The user can enter this information in response to a prompt along with their qualitative rating or ranking of the contribution of each of those features to overall complexity of the client. For example, the user may enter that client assets contribute more significantly to complexity than number of participants which is more significant than the number of plans. An advantage of the systems and methods described herein is the ability to convert any qualitative ranking or rating into a quantitative weight for purposes of classification. Accordingly, rankings or ratings can be numerical (on a scale of 1 to n) or textual (e.g., very low, low, moderate, high, very high) and can comprise a true relative ranking (e.g., ranked from 1 to n based on contribution to complexity where each feature receives a different rank) or a rating wherein multiple features are rated the same or similarly (e.g., both plan number and participant number are rated as moderate contributors to complexity).

Similarly, the user may be prompted to define feature values or value ranges for each of the identified contributory features and assign qualitative rankings or ratings to those values or value ranges. In either instance, the system may prompt for such rankings or ratings in a free-form text entry box or may provide a set of preselected ratings (e.g., via a drop down menu) for the user to select from for each feature and/or feature value.

The constrained genetic algorithm is used 205 to determine optimized weights for each of the selection of influential features and each feature value of the selection of influential features based on contribution to the classification based on the iterative and tiered genetic optimization discussed below. Once the optimized weights for the model have been obtained, a new, unclassified group member can be classified 207 using the determined weights and the feature values for that new group member. This process can be performed by the same user or group of users of may be performed by a different set of users. For example, one group may be responsible for training the model with access to a user interface for training as discussed above while another group of users may be limited in their access to the training interface but can access the trained model to assess new group members. In the financial services example, a staffing or intake group, for example, may have access to the trained model but not be able to create or alter the model via the training interface. That access may be limited to administrators or subject matter experts such as relationship managers.

For users such as a staffing or intake group accessing the trained model, a user interface displayed on a client computing device may prompt the user to enter client information for a new client. The model will have access to the trained model with optimized weights as well as the influential client features identified in the training process. The model can then use the user interface to prompt the user to enter the required feature values for the new client to be evaluated or to upload a file containing that information, contact the client directly to solicit that information, and/or prompt the user to provide a link or address from which that information can be retrieved.

In various embodiments, client survey data can be collected from experts such as experienced relationship managers. This data can include complexity ratings of existing or prospective clients based on various features, an identification of relevant features, a qualitative ranking of those features based on contribution to client complexity, and/or a qualitative assessment of different values or value ranges within those features based on their contribution to client complexity. While traditional training methods might then use a machine learning model to fit feature data to surveyed complexity ratings with uncontrollable weighting (e.g., any feature can be highly weights depending on data), systems and methods of the invention allow for the prioritization of features based on business hypotheses from the experienced relationship managers. That prioritization constrains the genetic algorithm used to identify the optimal set of weights such that the results are explainable from a business perspective.

For example, systems and methods of the invention, as applied to quantifying an otherwise qualitative assessment of client complexity in a financial services company, can consider features such as client assets, number of plan participants, number of plans, products, distance, tenure of client, industry of client, and/or call volume with client.

Subject matter experts (e.g., experienced relationship managers) can be enlisted at the outset to provide a complexity assessment for existing clients with known feature values or characteristics. In various embodiments, a more objective complexity assessment may be obtained and used (e.g., the staffing required for the existing client or the company resources devoted to the existing client). The experts can also evaluate potential client features that might impact complexity and identify and provide a qualitative rank (e.g., low, moderate, or high) of the most influential features. This expert assessment can then be used as a constraint in finding optimum feature weights for determining client complexity.

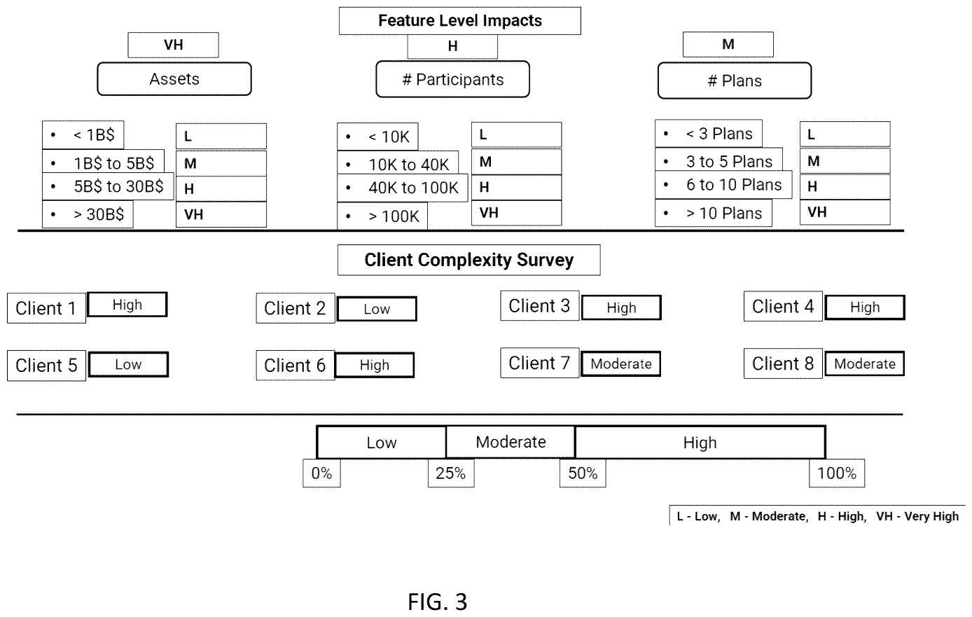

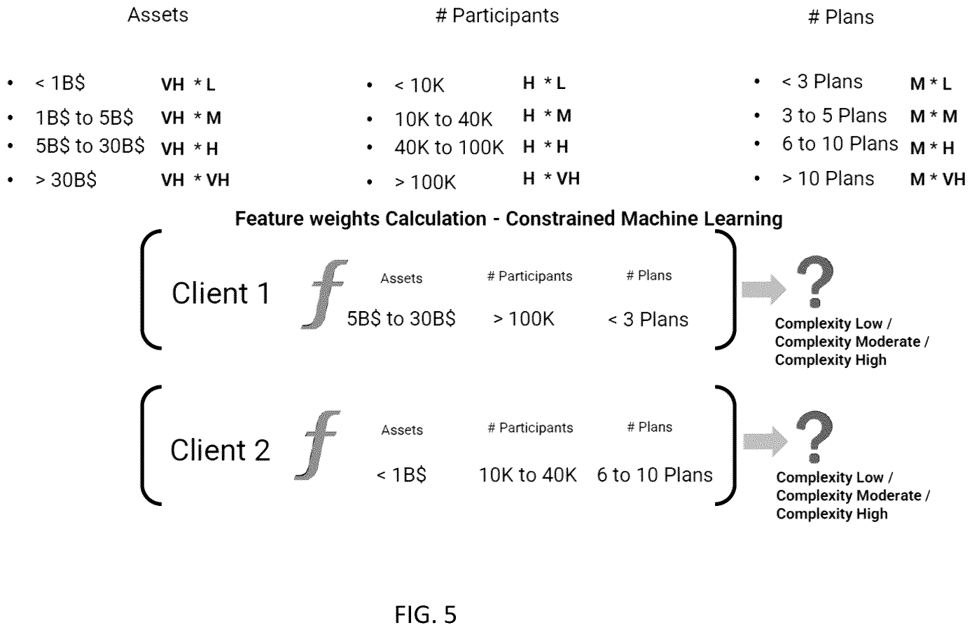

FIGS. 3-6 illustrate an exemplary classification of service industry clients by complexity according to certain embodiments. In various embodiments, the number of features and number of qualitative ranking levels can be substantially greater but are limited in this example for illustrative purposes. In the example of financial services, as shown in FIG. 3, expert input may indicate that the asset feature has a very high contribution to client complexity while the number of participants has a high contribution and the number of plans has a moderate contribution. The experts may also provide qualitative complexity rankings for a number of clients (8 in the example shown in FIG. 3) also ranging from low to high as well as providing feature level impacts for specific ranges of values (ranging from low to very high) within each of the identified influential features as shown in FIG. 3. The scale at the bottom indicates the distribution of client complexities across the survey (25% low, 25% moderate, and 50% high).

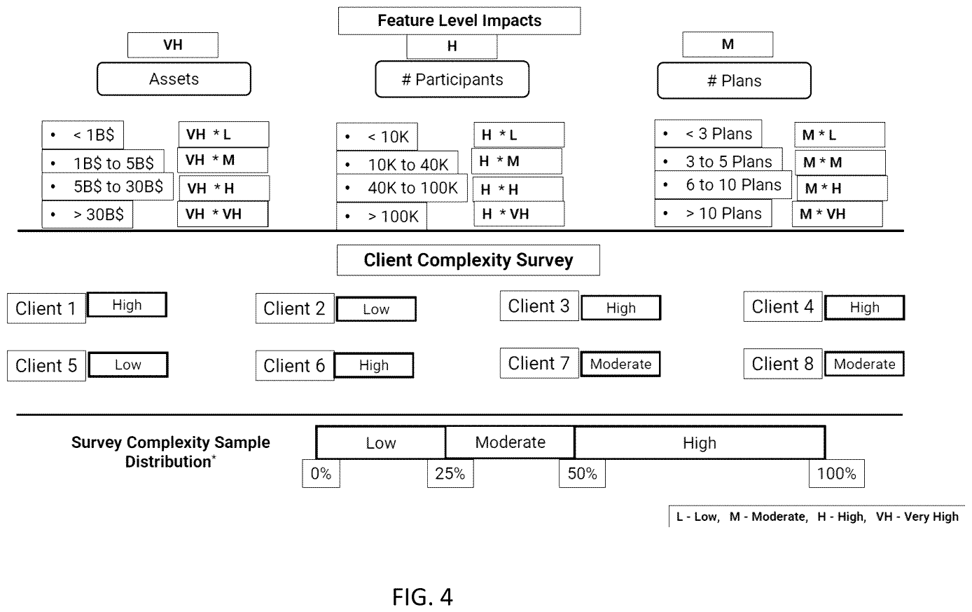

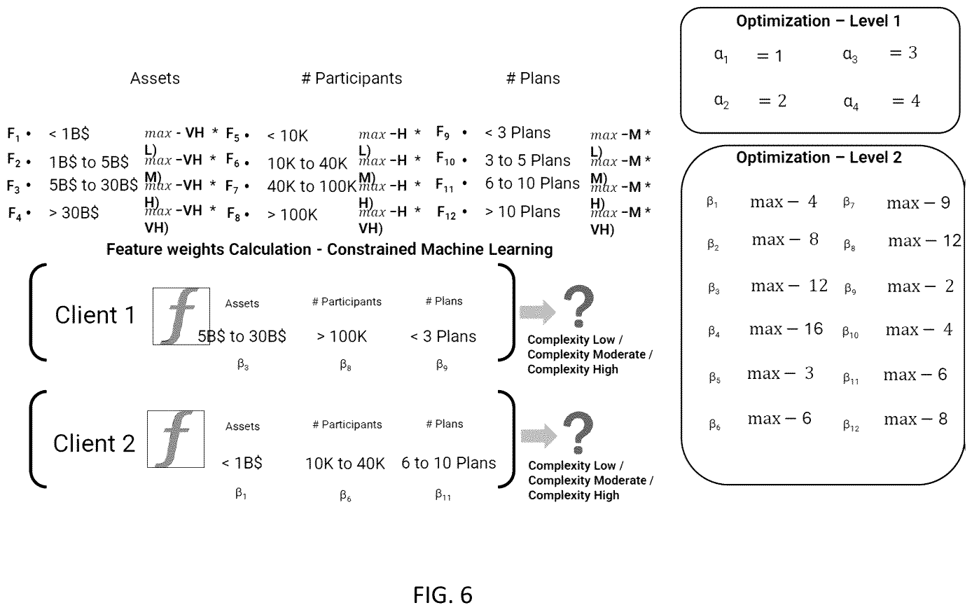

To determine feature value weights for complexity calculations, the qualitative feature rankings can be multiplied by the internal weight or qualitative ranking/evaluation of the client's value range for that specific feature as shown in FIG. 4 (e.g., under assets, a client with assets of $10 billion would be assigned a dot product of very high (for the feature ranking)*high (for the internal feature value ranking). Complexity is calculated as a function of the weighted feature values of a client where the weights comprise the above dot product as shown in FIG. 6.

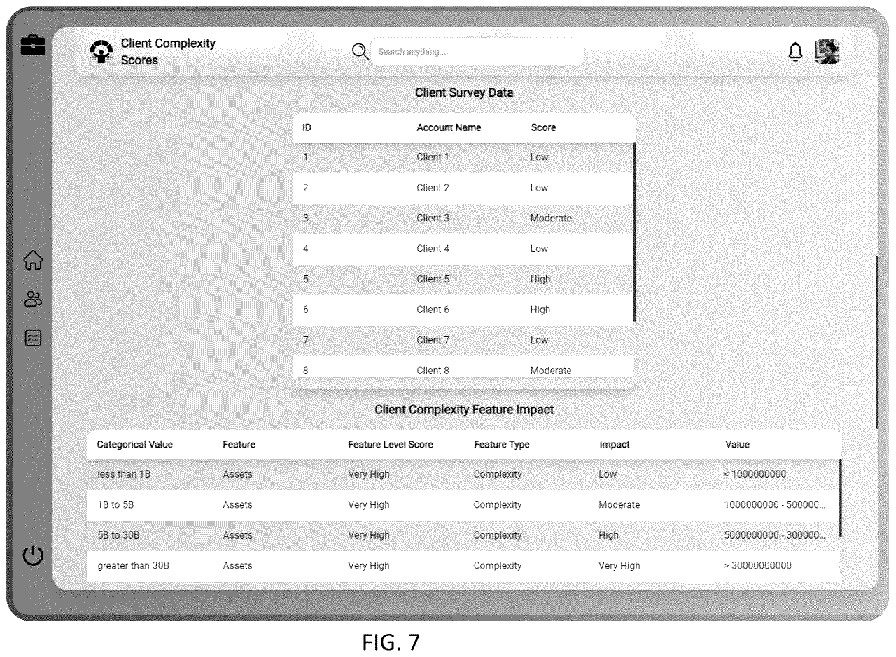

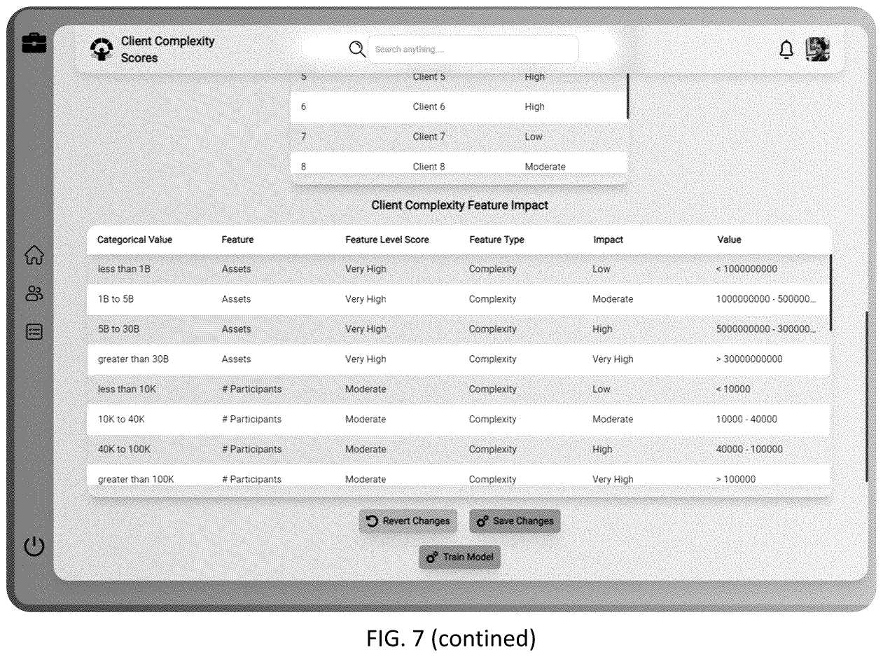

The various qualitative rankings can be assigned a variable such as α₁, α₂ . . . , αₙ for the rankings or ratings of the features' contribution to complexity overall and β₁, β₂ . . . , βₙ for the rankings or ratings of the values within that range's contribution to complexity as shown in FIG. 7. In certain embodiments, two levels of optimization may be used. First to determine optimized feature weights and then to determine optimized feature value weights within that feature. Arbitrary values can be assigned to the feature weights and a genetic algorithm can be optimized to obtain gene values for each a variable. Then, using those optimized weight values for each a variable, the p variables representing feature value ratings or rankings can be added and a genetic algorithm can be optimized to obtain gene values for each p variable. These genetic algorithms can be optimized with curated client data from existing clients annotated by subject matter experts as discussed above.

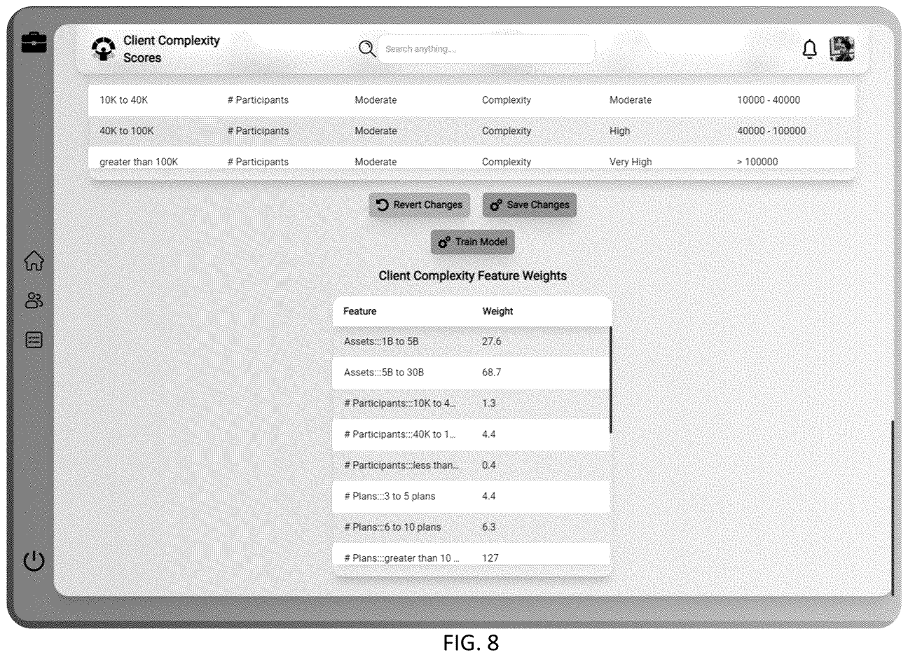

Once the aforementioned optimized weights are obtained, they can be added to the function used to relate weighted feature values to overall client complexity and applied to new clients to determine complexity. FIGS. 7 and 8 illustrate exemplary user interfaces for interacting with a data group classification system according to various embodiments. FIG. 7 shows a user interface for entering expert rankings/rating for training a complexity evaluation model. FIG. 8 shows a user interface providing the determined feature value weights based on the training input.

In certain embodiments, an objective function such as the following may be maximized:

$$\begin{matrix}maximize ( f 1 score ) \\ where f 1 \_ score = \frac{2 * TP}{( 2 * TP ) + FP + FN} \\ TP = True Positives , TN = True Negatives \\ FP = False Positives , FN = False Negatives\end{matrix}$$

The objective function can be subject to the following steps:

### Step 1: (Level 1 Optimization)

$$0 < {α}_{1} < {α}_{2} < {α}_{3} … < {α}_{n} < max bound$$

$$\begin{matrix}where α = Ordinal Level ( ie . Low , Moderate , High … ) \\ n = Number of Ordinal Levels\end{matrix}$$

$$\begin{matrix}ie . 0 < {α}_{1} < {α}_{2} \\ {α}_{1} < {α}_{2} < {α}_{3} \\ {α}_{n - 1} < {α}_{n} < max bound\end{matrix}$$

### Step 2: (Level 2 Optimization)

$$0 < {β}_{1} < {β}_{2} < {β}_{3} < … . < {β}_{k}$$

$$where k = Number of Features$$

$$\begin{matrix}i . e 0 < {β}_{1} < {α}_{i} * {α}_{j} \\ {β}_{1} < {β}_{2} < {α}_{i} * {α}_{j} \\ {β}_{k - 1} < {β}_{k} < {α}_{i} * {α}_{j}\end{matrix}$$

$$\begin{matrix}where 1 \leq i , j \leq n ( Number of Ordinal Levels ) \\ values i , j could differ for each β\end{matrix}$$

A complexity score can then be derived using β derived from Step 2 to compute the Optimized Weight (OW). The complexity score may be represented as follows:

$$f ( complexity score ) = ( {OW}_{1} * {Feature}_{1} ) + ( {OW}_{2} * {Feature}_{2} ) + … + ( {OW}_{k} * {Feature}_{k} )$$

$$\begin{matrix}where k = Number of Features \\ OW = Optimized Weight\end{matrix}$$

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for classifying data group members by features thereof:
providing to a constrained genetic algorithm:
a sample group, each sample group member comprising a plurality of data features, each of the plurality of data features comprising a feature value;
a classification for each member of the sample group;
a selection of influential features selected from the plurality of data features;
a relative qualitative rank of the selection of influential features; and
a relative internal weight for each feature value of the selection of influential features;
using the constrained genetic algorithm to determine optimized weights for each of the selection of influential features and each feature value of the selection of influential features based on contribution to the classification; and
classifying a new group member using the determined weights.

2. The computerized method of claim 1, wherein the classification for each member of the sample group is determined by one or more subject matter experts.

3. The computerized method of claim 2, wherein the selection of influential features is selected by one or more subject matter experts.

4. The computerized method of claim 3, wherein the relative qualitative rank of the selection of influential features and the relative internal weight for each feature value of the selection of influential features are both determined by one or more subject matter experts.

5. The computerized method of claim 4, wherein each sample group member and the new group member consist of a business client.

6. The computerized method of claim 5, wherein classification is selected from client complexity, required time for client management, required knowledge for client management, or required staffing for client management for the business client.

7. The computerized method of claim 5, wherein the business client is a financial services client.

8. The computerized method of claim 7, wherein the features comprise one or more of client assets, number of plans, number of participants, client distance, client industry, client tenure, and products used by client.

9. The computerized method of claim 7, wherein the one or more subject matter experts comprise experienced client relationship managers.

10. The computerized method of claim 6, further comprising determining staffing for the new client based off the classification of the new client.

11. A computer system for classifying data group members by features, the system comprising a processor in communication with a non-transient memory and operable to perform the steps of:
providing to a constrained genetic algorithm:
a sample group, each sample group member comprising a plurality of data features, each of the plurality of data features comprising a feature value;
a classification for each member of the sample group;
a selection of influential features selected from the plurality of data features;
a relative qualitative rank of the selection of influential features; and
a relative internal weight for each feature value of the selection of influential features;
using the constrained genetic algorithm to determine optimized weights for each of the selection of influential features and each feature value of the selection of influential features based on contribution to the classification; and
classifying a new group member using the determined weights.

12. The computer system of claim 11, wherein the classification for each member of the sample group is determined by one or more subject matter experts.

13. The computer system of claim 12, wherein the selection of influential features is selected by one or more subject matter experts.

14. The computer system of claim 13, wherein the relative qualitative rank of the selection of influential features and the relative internal weight for each feature value of the selection of influential features are both determined by one or more subject matter experts.

15. The computer system of claim 14, wherein each sample group member and the new group member consist of a business client.

16. The computer system of claim 15, wherein classification is selected from client complexity, required time for client management, required knowledge for client management, or required staffing for client management for the business client.

17. The computer system of claim 15, wherein the business client is a financial services client.

18. The computer system of claim 17, wherein the features comprise one or more of client assets, number of plans, number of participants, client distance, client industry, client tenure, and products used by client.

19. The computer system of claim 17, wherein the one or more experts comprise experienced client relationship managers.

20. The computer system of claim 16, further operable to determine staffing for the new client based off the classification of the new client.
